(19) United States
(12) Patent Application Publication
(10) Pub. No.: US 2023/0229615 A1
(43) Pub. Date: Jul. 20, 2023

(54) DATA TRANSFER AND POWER DELIVERY FOR ROBOT VIA DIRECT CONTACT WITH DOCKING STATION

(71) Applicant: Corvus Robotics, Inc., Boston, MA (US)

(72) Inventors: Bryan Monti, Boston, MA (US); Mohammed Kabir, Boston, MA (US)

(21) Appl. No.: 17/580,140

(22) Filed: Jan. 20, 2022

(51) Int. Cl. G06F 13/40; G06F 1/26

(52) U.S. Cl. CPC G06F 13/4068; G06F 1/266

(57) ABSTRACT

The present disclosure provides a mechanism for data transfer for a robot using pre-existing network standards (e.g., USB-C, Thunderbolt, CAN-bus, or Ethernet) and for power delivery, both being implemented through direct contact pins on a robot and the corresponding contact pads on a docking station. The robot can be a legged or wheeled ground vehicle, an aerial vehicle such as a drone, an underwater robot, or any other suitable robots. The docking station may include a computing device, to which the robot can transfer data. The contact pins and pads can be arranged to have a rotational symmetry.

### TECHNICAL FIELD

The present disclosure relates to data transfer and power delivery for a robot via direct physical contact with a docking station.

### BACKGROUND

Prior art has described data transfer between a robot and a docking station over a wireless LAN or via fast wired data transfer in the form of a tether, which limits the range of the robot to the length of the tether.

### SUMMARY

In one aspect, the present disclosure provides a robot receivable by a docking station, the robot comprising: a contact structure to form physical contact with the docking station; and a contact interface on the contact structure, the contact interface comprising a plurality of power pins and data pins so as to be electrically connected to the docking station when the contact interface of the robot contacts a corresponding contact interface of the docking station.

In one embodiment, the power pins and the data pins are arranged at random locations of the contact interface.

In one embodiment, the power pins and the data pins are arranged on the contact interface to have a rotational symmetry of at least order two.

In one embodiment, the contact interface is configured to have one of a rectangular shape, a triangular shape, a hexagonal shape, and an oval shape.

In one embodiment, the robot further comprises a battery electrically connected to the power pins and a controller electrically connected to the data pins.

In one embodiment, the robot is an aerial drone and further comprises a frame and one or more propellers on the frame, wherein the contact structure is a landing structure disposed below the frame.

In one embodiment, the contact interface is disposed at a bottom surface of the landing structure.

In one embodiment, the landing structure has a protrusive shape at a bottom portion of the landing structure complimentary to a recessed shape at a top portion of the docking station, or vice versa.

In another aspect, the present disclosure provides a docking station capable of receiving a robot, the docking station comprising: a main body; a reception dock on the main body; and a contact interface at a central portion of the reception dock, the contact interface comprising a plurality of power pads and data pads so as to be electrically connected to the robot when the contact interface of the docking station contacts a corresponding contact interface of the robot; wherein the power pads and the data pads are arranged on the contact interface to have a rotational symmetry of at least order two.

In one embodiment, the contact interface is configured to have one of a rectangular shape, a triangular shape, a hexagonal shape, and an oval shape.

In one embodiment, the docking station further comprises a power converter electrically connected to the power pads, the power converter capable of receiving wall power.

In one embodiment, the data pads are connectable to a data network.

In one embodiment, the reception dock has a recessed shape complementary to a protrusive shape at a bottom portion of the robot.

In one embodiment, the data pads are physical links that correspond to channels in a network protocol to transfer data in accordance with the network protocol.

In still another aspect, the present disclosure provides a combination of a robot and a docking station, wherein the robot comprises: a contact structure; and a contact interface on the contact structure, the contact interface comprising a plurality of power pins and data pins; wherein the docking station comprises: a main body; a reception dock on the main body; and a corresponding contact interface at a central portion of the reception dock, the corresponding contact interface comprising a plurality of power pads and data pads; wherein the power pins and the data pins of the robot are aligned with the power pads and the data pads of the docking station such that the power pins of the robot are electrically connectable to the power pads of docking station and that the data pins of the robot are electrically connectable to the data pads of docking station; wherein the power pins and the data pins of the robot are arranged on the contact interface to have a rotational symmetry of at least order two; and wherein the power pads and the data pads of the docking station are arranged on the corresponding contact interface to have a rotational symmetry same as that of the power pins and the data pins of the robot.

In one embodiment, the contact interface of the robot and the corresponding contact interface of the docking station are configured to have the same shape, which is one of a triangular shape, a hexagonal shape, and an oval shape.

In one embodiment, the robot further comprises a battery electrically connected to the power pins of the robot and a controller electrically connected to the data pins of the robot.

In one embodiment, the robot is an aerial drone and further comprises a frame and one or more propellers on the frame, wherein the contact structure is a landing structure disposed below the frame.

In one embodiment, the contact interface of the robot is disposed at a bottom surface of the landing structure.

In one embodiment, the landing structure has a protrusive shape at a bottom portion of the landing structure complimentary to a recessed shape of the reception dock of the docking station.

In one embodiment, the docking station further comprises a power converter electrically connected to the power pads of the docking station, the power converter capable of receiving wall power.

In one embodiment, the data pads of the docking station are connectable to a data network.

### BRIEF DESCRIPTION OF THE DRAWINGS

FIG. 1 schematically illustrates a side view of a robot and a docking station of the robot in accordance with an embodiment of the present disclosure.

FIG. 2 illustrates a block diagram of a robot in accordance with an embodiment of the present disclosure.

FIG. 3 illustrates a bottom view of a robot in accordance with an embodiment of the present disclosure.

FIG. 4 illustrate a top view of a docking station in accordance with an embodiment of the present disclosure.

FIG. 5 schematically illustrate an exemplary arrangement of contact pads on a docking station in accordance with an embodiment of the present disclosure.

### DETAILED DESCRIPTION

The present disclosure provides a mechanism for data transfer for robots using pre-existing network standards (such as, Universal Serial Bus (USB), Thunderbolt, Controller Area Network (CAN) bus, or Ethernet) and for power delivery, both implemented through direct contact pins on a robot and the corresponding pads on a docking station. The robot may be a legged or wheeled ground vehicle, an aerial vehicle such as a drone, an underwater robot, or any other suitable robots. The docking station may include a computing device, to which the robot can transfer data.

By making direct contact between the contact pins of a robot (for example, contact pins on a drone's bottom landing gear) and the contact pads of a docking station, a high-speed telecommunication channel can be established to allow transfer of data files of very large sizes (such as high-fidelity sensor data collected by the robot) at a data rate much faster than data transfer over a wireless LAN. In addition, the contact pins and pads can be used to charge the robot's batteries (depending on the network standard, such as via USB-PD, Thunderbolt, PoE, or other protocols), allowing the docking station to also deliver power to the robot in addition to data transfer.

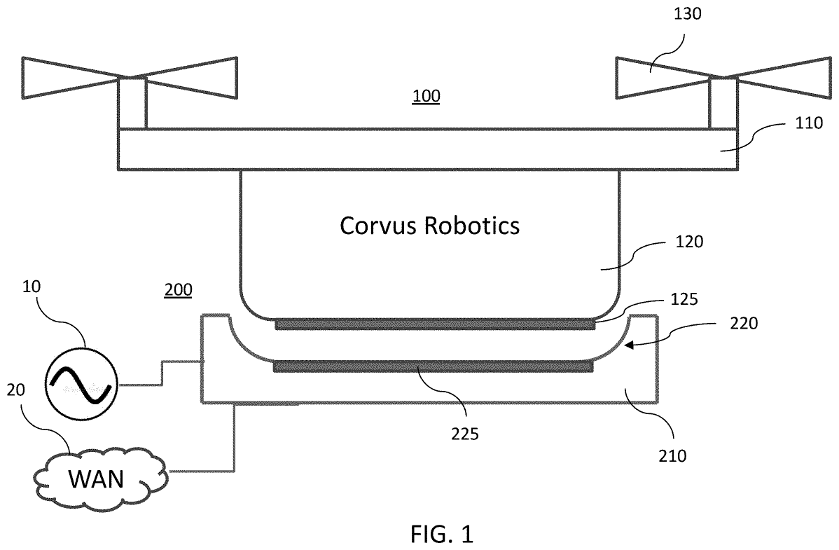

FIG. 1 schematically illustrates a side view of a robot 100 and a docking station 200 of robot 100 in accordance with an embodiment of the present disclosure. In this embodiment, robot 100 is an aerial drone including a frame 110, one or more landing structures 120 below frame 110, and one or more propellers 130 on frame 110. For a robot other than the aerial drone, landing structures 120 can refer to any structure of the robot that can establish physical contact to outside of the robot. Frame 110 may provide support for propellers 130 which may be fixed or attached to and positioned above frame 110. It is appreciated that other positions for propellers 130 in relation to frame 100 are possible. In addition, robot 100 may include a plurality of propellers 130 equaling four rotors. It is appreciated that other quantities of propellers 130 are possible, such as one, two, six, eight or any other suitable quantity. Landing structures 120 may be attached to frame 110 and arranged to position robot 100 in an upright position when robot 100 is in an inactive, idle, or rest position. In this embodiment, a contact interface 125 having a substantially rectangular shape is arranged on a bottom surface of landing structure 120. It is appreciated that, in other embodiments, contact interface 125 can be arranged on any other suitable location of robot 100.

Docking station 200 includes a main body 210, a reception dock 220 on an upper portion of main body 210, and a corresponding contact interface 225 (having a substantially rectangular shape) at a central portion of reception dock 220. Corresponding contact interface 225 may be electrically connected to a power source 10 (e.g., 110V AC wall power) and a data network 20 (e.g., a wide area network, a 4G-LTE network, etc.) so as to deliver power and transfer data to robot 100 when contact interface 125 of robot 100 is in direct physical contact and properly aligned with corresponding contact interface 225 of docking station 200. As shown in FIG. 1, reception dock 220 may be configured to have a recessed shape substantially complementary to the protrusive shape of landing structure 120, so as to ensure that contact interface 125 and corresponding contact interface 225 are properly aligned when robot 100 lands on docking station 200. In one embodiment, docking station 200 may additional include an AC-to-DC power converter (not shown) connected between power source 10 and corresponding contact interface 225. It is appreciated that, in some embodiments, especially when robot 100 is a non-aerial vehicle, docking station 200 may be flat and without a recessed reception dock 220. Further, contact interface 225 is not limited to a substantially rectangular shape and can be any suitable shape in accordance with design choices.

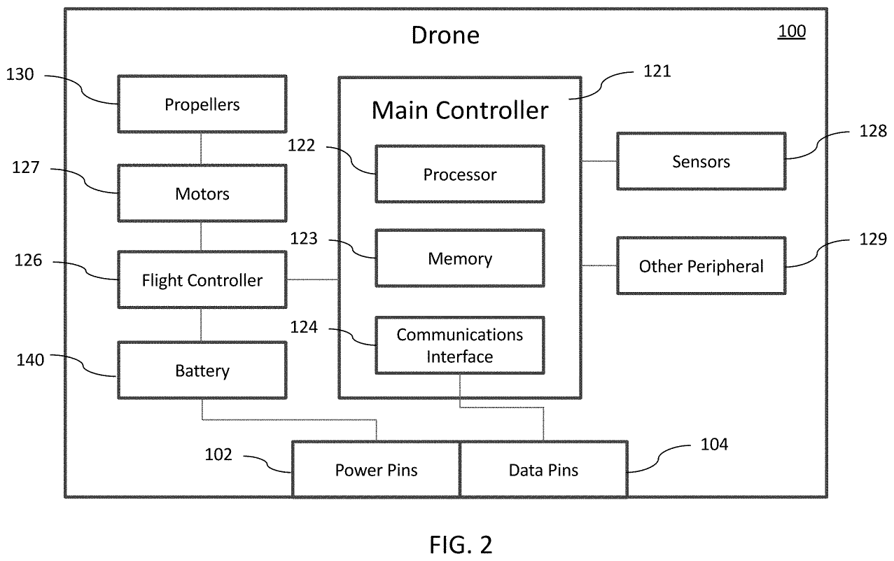

FIG. 2 illustrates a block diagram of a robot 100 in accordance with an embodiment of the present disclosure. In this embodiment, robot 100 is an aerial drone having at least one controller (e.g., main controller 121 and/or flight controller 126). Main controller 121 can be configured to provide communication and processing functionality for robot 100, while flight controller 126 can be configured to receive instructions from main controller 121 and drive one or more motors 127 accordingly. Robot 100 may have a plurality of motors 127 coupled to respective propellers 130. In other embodiments, main controller 121 can implement flight controller 126 operations and drive motors 112 directly, or flight controller 126 can comprise main controller 121, or vice versa. Robot 100 includes a battery 140 to provide power for all of its electrical components.

In one embodiment, main controller 121 (and/or flight controller 126) includes a processor 122, memory 123, and a communications interface 124. Processor 122 provides processing functionality for main controller 121 (or components thereof) and can include any appropriate quantity of microprocessors, digital signal processors, micro-controllers, circuitry, field programmable gate array (FPGA) or other processing systems. Processor 122 can execute one or more software programs embodied in a non-transitory computer readable medium that implement techniques described herein.

Memory 123 can be an example of tangible, computer-readable storage medium that provides storage functionality to store various data and or program code associated with operation of main controller 121, such as software programs and/or code segments, or other data to instruct processor 122, and possibly other components of main controller 121, to perform the functionality described herein. In some embodiments, memory 123 can be integrated with processor 122, can comprise stand-alone memory, or can be a combination of both. Some examples of the memory 123 can include removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In various embodiments, memory 123 can include removable integrated circuit card (ICC) memory, such as memory provided by a subscriber identity module (SIM) card, a universal subscriber identity module (USIM) card, a universal integrated circuit card (UICC), and so on.

Communications interface 124 may communicate with components of main controller 121. For example, communications interface 108 can retrieve data from a storage in main controller 121, transmit data for storage in main controller 121, etc. Communications interface 124 can also be communicatively coupled with processor 122 to facilitate data transfer between components of main controller 121 and processor 104. It is appreciated that while communications interface 124 is described as a component of main controller 121, one or more components of communications interface 124 can be implemented as external components communicatively coupled to main controller 121 via wired and/or wireless connections. Main controller 121 can also be connected to one or more input/output (I/O) devices via communications interface 108 and/or via direct or indirect communicative coupling with processor 122.

As shown in FIG. 2, main controller 121 is communicatively coupled to one or more sensors 128 (e.g., a laser scanner, photodetector array, camera, or the like) on robot 100. In other embodiments, robot 100 further includes other peripheral devices 129 including other sensors (e.g., temperature sensors, inertial sensors, altitude detectors, LIDAR devices, laser depth sensors, radar/sonar devices, wireless receivers/transceivers, RFID detectors, etc.), an indoor position determining system (e.g., camera vision based SLAM positioning system employing one or more monocular cameras, one or more stereoscopic camera, one or more laser depth sensors, one or more LIDAR devices, laser and/or ultrasonic rangefinders, an inertial sensor based positioning system, an RF/WIFI/Bluetooth triangulation based sensor system, or the like), a graphics processor 124 (e.g., to provide processing functionality for the indoor positioning system 122, and/or to implement optical character recognition (OCR), machine learning, computer vision, or any other image processing algorithm(s)), etc.

Main controller 121 can utilize sensor inputs to detect identifiers on inventory items and/or other information (e.g., contextual information (e.g., location of an inventory item, time, temperature, humidity, pressure, etc.) or product information (e.g., label information for the inventory item, expiration information, production date, environmental tolerances, quantity, size/volume, product weight (if printed on the inventory item), etc.), navigate robot 100 (e.g., by avoiding obstacles, detecting reference points, updating a dynamic flight path for robot 100, and landing), and to stabilize and/or localize its position.

Contact interface 125 of robot 100 includes a plurality of power pins 102 and data pins 104. Power pins 102 are electrically connected to battery 104 for charging/discharging battery 140, while data pins 104 are electrically connected to communications interface 124 of main controller 121 for data transfer. In various embodiments, data pins 104 are arranged in accordance with an existing wired network standards (such as, Universal Serial Bus (USB), Thunderbolt, Controller Area Network (CAN) bus, or Ethernet) or may be the same as the power pins depending on network standard.

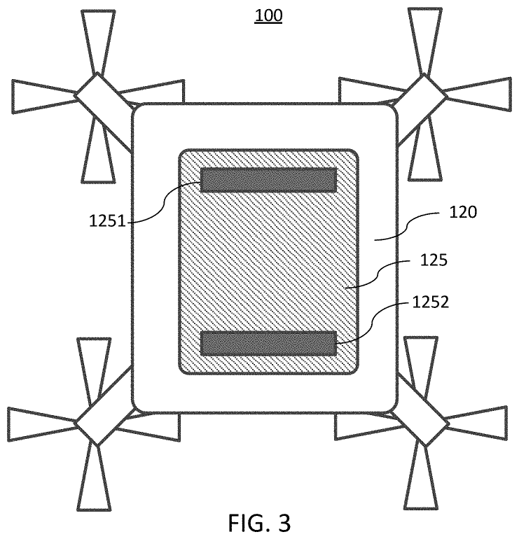

FIG. 3 illustrates a bottom view of robot 100 in accordance with an embodiment of the present disclosure. As shown in FIG. 3, in this embodiment, landing structure 120 of robot 100 includes a first set of contact pin 1251 and a second set of contact pins 1252 arranged on a bottom surface thereof. Each of first and second sets of contact pins 1251 and 1252 may include a plurality of power pins and data pins symmetrically arranged so as to ensure power and data connections when robot 100 is landed on docking station 200 at any one of the two possible landing orientations (i.e., 180 degrees apart). Although two sets of contact pins are shown and described, it is appreciated that any suitable quantity of sets of contact pins (e.g., one set, four sets, etc.) can be used based on design choices, and additional landing orientations may be possible. It is appreciated that, in some embodiments, contact interface 125 of robot 100 can be formed at other locations on robot 100. For example, when robot100 is a non-aerial vehicle, contact pins 1251 and 1252 can be located at the front face, the lateral face, or the rear face of robot 100, so as to make contact with a wall-mount or ground based docking station 200.

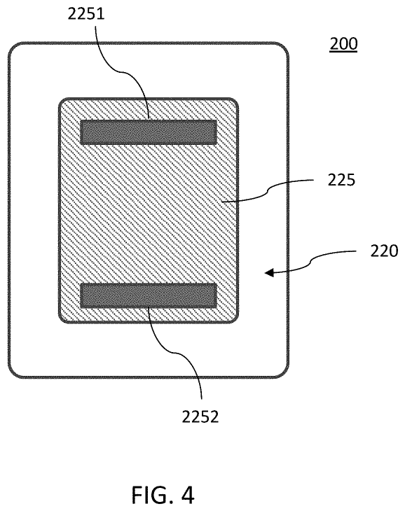

FIG. 4 illustrate a top view of docking station 200 in accordance with an embodiment of the present disclosure. As shown in FIG. 4, in this embodiment, corresponding contact interface 225 of reception dock 220 includes a first set of contact pads 2251 and a second set of contact pads 2252. Each of first and second sets of contact pads 2251 and 2252 may include a plurality of power pads and data pads symmetrically arranged so as to ensure power and data connections when robot 100 is landed on docking station 200 at any one of the quantity possible landing orientations (i.e., 180 degrees apart). It should be noted that the quantity and arrangement of power pads and data pads of first and second sets of contact pads 2251 and 2252 should match the quantity and arrangement of power pins and data pins of first and second sets of contact pins 1251 and 1252.

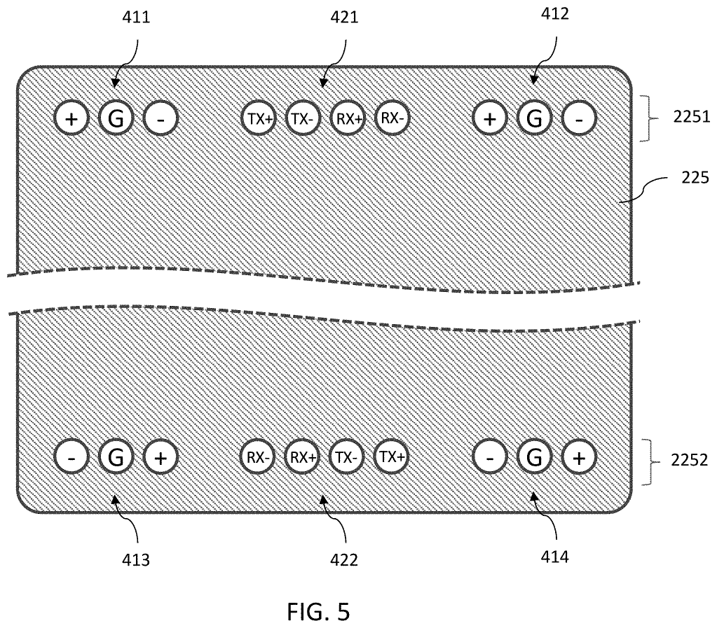

FIG. 5 schematically illustrate an exemplary arrangement of contact pads 2251 and 2252 of docking station 200 in accordance with an embodiment of the present disclosure. As shown in FIG. 5, in this embodiment, first set of contact pads 2251 includes two sets of power pads 411 and 412, and data pads 421, while second set of contact pads 2252 includes two sets of power pads 413 and 414, and data pads 422. It is appreciated that the quantity and arrangement of the quantity and arrangement of power pins and data pins of first and second sets of contact pins 1251 and 1252 should match the power pads and data pads of first and second sets of contact pads 2251 and 2252. In some embodiments, only one set of contact pads are arranged on docking station 200. In some embodiments, each contact pad can be positioned at a random location of docking station 200 based on design choices, so long as the arrangement of contact pads of docking station 200 matches with the arrangement of corresponding contact pins of robot 100.

In this embodiment, each of power pads 411, 412, 413, and 414 includes a positive pad, a negative pad, and a ground pad to supply AC or DC power to robot 100 when pins of contact interface 125 are in physical contact and properly aligned with pads of corresponding contact interface 225. Each of power pads 411, 412, 413, and 414 can provide electric power to robot 100 independently from each other. In this embodiment, Ethernet standard is used for data transfer. As such, each of data pads 421 includes two transmit pads (TX+ and TX−) and two receive pads (RX+ and RX−) to enable data transfer to and from robot 100 when pins of contact interface 125 are in physical contact and properly aligned with pads of corresponding contact interface 225. As shown in FIG. 5, power pads 411, 412 and data pads 421 are symmetrically arranged with respect to power pads 413, 414 and data pads 422 such that corresponding contact interface 225 (having a substantially rectangular shape) looks and functions in the same manner after being rotated by 180 degrees (a rotational symmetry of order 2).

In other embodiments, contact interface 123 in FIG. 3 and corresponding contact interface 225 in FIG. 4 may have any suitable shapes, such as a triangular shape, a hexagonal shape, an oval shape, etc. For example, contact interface 123 and corresponding contact interface 225 may have a substantially triangular shape, such that power pins/pads and data pins/pads are arranged thereon to have a rotational symmetry of order 3 (i.e., looks the same for each 120 degrees rotation). For example, contact interface 123 and corresponding contact interface 225 may have a substantially hexagonal shape, such that power pins/pads and data pins/pads are arranged thereon to have a rotational symmetry of order 6 (i.e., same for each 60 degrees rotation). It is appreciated that pins and pads are used interchangeably herein to refer to the physical contact points of contact interface 125 and corresponding contact interface 225.

Software programs can be configured to transfer data and/or charge robot 100 upon connection and physical contact of robot 100 and docking station 200. In addition, there can be software that dynamically switches data transfer from physical standard connection to wireless LAN upon detection of the contact pins/pads are no longer connected, or vice versa. This allows for seamless data transfer during and after robot operation.

For the purposes of describing and defining the present disclosure, it is noted that terms of degree (e.g., “substantially,” “slightly,” “about,” “comparable,” etc.) may be utilized herein to represent the inherent degree of uncertainty that may be attributed to any quantitative comparison, value, measurement, or other representation. Such terms of degree may also be utilized herein to represent the degree by which a quantitative representation may vary from a stated reference (e.g., about 10% or less) without resulting in a change in the basic function of the subject matter at issue. Unless otherwise stated herein, any numerical value appearing in the present disclosure are deemed modified by a term of degree (e.g., “about”), thereby reflecting its intrinsic uncertainty.

Although various embodiments of the present disclosure have been described in detail herein, one of ordinary skill in the art would readily appreciate modifications and other embodiments without departing from the spirit and scope of the present disclosure as stated in the appended claims.

What is claimed is:

1. A robot receivable by a docking station, the robot comprising:
a contact structure to form physical contact with the docking station; and
a contact interface on the contact structure, the contact interface comprising at least two sets of identical power pins and at least two sets of identical data pins so as to be electrically connected to the docking station when the contact interface of the robot contacts a corresponding contact interface of the docking station;
wherein the power pins and the data pins are mechanically arranged on the contact interface to have a rotational symmetry of at least order two.

2. The robot of claim 1, wherein the power pins and the data pins are arranged at random locations of the contact interface.

3. (canceled)

4. The robot of claim 1, wherein the contact interface is configured to have one of a rectangular shape, a triangular shape, a hexagonal shape, and an oval shape.

5. The robot of 1, further comprising a battery electrically connected to the power pins and a controller electrically connected to the data pins.

6. The robot of claim 1, wherein the robot is an aerial drone and further comprises a frame and one or more propellers on the frame, wherein the contact structure is a landing structure disposed below the frame.

7. The robot of claim 6, wherein the contact interface is disposed at a bottom surface of the landing structure.

8. The robot of 6, wherein the landing structure has a protrusive shape at a bottom portion of the landing structure complimentary to a recessed shape at a top portion of the docking station, or vice versa.

9. A docking station capable of receiving a robot, the docking station comprising:
a main body;
a reception dock on the main body; and
a contact interface at a central portion of the reception dock, the contact interface comprising at least two sets of identical power pads and at least two sets of identical data pads so as to be electrically connected to the robot when the contact interface of the docking station contacts a corresponding contact interface of the robot;
wherein the power pads and the data pads are mechanically arranged on the contact interface to have a rotational symmetry of at least order two.

10. The docking station of claim 9, wherein the contact interface is configured to have one of a rectangular shape, a triangular shape, a hexagonal shape, and an oval shape.

11. The docking station of claim 9, further comprising a power converter electrically connected to the power pads, the power converter capable of receiving wall power.

12. The docking station of claim 9, wherein the data pads are connectable to a data network.

13. The docking station of claim 9, wherein the reception dock has a recessed shape complementary to a protrusive shape at a bottom portion of the robot.

14. The docking station of claim 9, the data pads are physical links that correspond to channels in a network protocol to transfer data in accordance with the network protocol.

15. A combination of a robot and a docking station,
wherein the robot comprises:
a contact structure; and
a contact interface on the contact structure, the contact interface comprising at least two sets of identical power pins and at least two sets of identical data pins;
wherein the docking station comprises:
a main body;
a reception dock on the main body; and
a corresponding contact interface at a central portion of the reception dock, the corresponding contact interface comprising at least two sets of identical power pads and at least two sets of identical data pads;
wherein the power pins and the data pins of the robot are aligned with the power pads and the data pads of the docking station such that the power pins of the robot are electrically connectable to the power pads of docking station and that the data pins of the robot are electrically connectable to the data pads of docking station;
wherein the power pins and the data pins of the robot are mechanically arranged on the contact interface to have a rotational symmetry of at least order two; and
wherein the power pads and the data pads of the docking station are mechanically arranged on the corresponding contact interface to have a rotational symmetry same as that of the power pins and the data pins of the robot.

16. The combination of claim 15, wherein the contact interface of the robot and the corresponding contact interface of the docking station are configured to have the same shape, which is one of a triangular shape, a hexagonal shape, and an oval shape.

17. The combination of 15, wherein the robot further comprises a battery electrically connected to the power pins of the robot and a controller electrically connected to the data pins of the robot.

18. The combination of claim 15, wherein the robot is an aerial drone and further comprises a frame and one or more propellers on the frame, wherein the contact structure is a landing structure disposed below the frame.

19. The combination of claim 18, wherein the contact interface of the robot is disposed at a bottom surface of the landing structure.

20. The combination of 18, wherein the landing structure has a protrusive shape at a bottom portion of the landing structure complimentary to a recessed shape of the reception dock of the docking station.

21. The combination of 15, wherein the docking station further comprises a power converter electrically connected to the power pads of the docking station, the power converter capable of receiving wall power.

22. The combination of 15, wherein the data pads of the docking station are connectable to a data network.
